(19) United States
(12) Patent Application Publication
(10) Pub. No.: US 2026/0119517 A1
(43) Pub. Date: Apr. 30, 2026

(54) DATABASE SYSTEMS AND METHODS FOR FLEXIBLE DATA DISPLAY

(71) Applicant: Salesforce, Inc., San Francisco, CA (US)

(72) Inventors: Angela Liu, San Francisco, CA (US); Nick Towle, Raleigh, NC (US); Mayank Lohiya, Hyderabad (IN); Aayushi Bhargava, Emeryville, CA (US); Dai Duong Doan, San Francisco, CA (US); Dongyao Ling, San Francisco, CA (US); Qiaoge Zheng, Toronto (CA)

(73) Assignee: Salesforce, Inc., San Francisco, CA (US)

(21) Appl. No.: 18/926,201

(22) Filed: Oct. 24, 2024

(51) Int. Cl. G06F 16/25; G06F 9/451; G06F 16/26

(52) U.S. Cl. CPC G06F 16/25; G06F 9/451; G06F 16/26

(57) ABSTRACT

Database systems and methods are provided for dynamic contextualization of an application provided at a client device. In response to a request for a graphical user interface (GUI) display associated with a virtual application, a service identifies a destination context associated with the client application based at least in part on the request, generates a constituent component corresponding to a GUI element associated with the GUI display based on the destination context, wherein the constituent component comprises behavioral code for retrieving data from a respective data source in accordance with the destination context, generates an aggregate component corresponding to the GUI display based on the destination context for incorporating the constituent component within the GUI display based at least in part on a configuration of the GUI display at the database system, and provides the components to the client application for execution responsive to the request.

### TECHNICAL FIELD

One or more implementations relate to the field of database systems, and more specifically, to supporting different client contexts in dynamic applications that interact with records at a database system.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In practice, it is desirable to provide a cloud-based database system that provides extensibility and flexibility to support applications across different clients using different frameworks. For example, in addition to supporting application customizations within the context of a web browser or other desktop application that allow users to interact with a cloud-based database system to retrieve and access data and other cloud-based services or functionality, it is desirable to provide a similar user experience in the context of a mobile application at a user's cellular phone, tablet or other mobile device. Moreover, in addition to supporting common features and functionality, in some instances, it is desirable to support more customizable user experiences with customizations that can be integrated with an application, adding another layer of complexity between the cloud-based database system and the end user. Accordingly, it is desirable to allow for dynamically generated customized applications to be adaptable to support different client-side contexts to improve user experiences without requiring hard coding or other changes to the underlying application frameworks.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system according to some example implementations;

FIG. 2 depicts an exemplary graphical user interface (GUI) display suitable for presentation in the computing system of FIG. 1 according to some example implementations;

FIG. 3 is a block diagram illustrating exemplary web components suitable for use in the computing system of FIG. 1 according to some example implementations;

FIG. 4 is a flow diagram illustrating a dynamic contextualization process suitable for implementation in the computing system of FIG. 1 according to some example implementations;

FIGS. 5-7 depict exemplary code segments suitable for use with one or more web components in connection with the dynamic contextualization process of FIG. 4 according to some example implementations;

FIG. 8A is a block diagram illustrating an electronic device according to some example implementations; and

FIG. 8B is a block diagram of a deployment environment according to some example implementations.

### DETAILED DESCRIPTION

The following description describes implementations for dynamically generating display components for client-side presentation in the context of a database system that supports multiplatform web applications that are customizable or user-configurable or other software as a service (SaaS) environment. As described in greater detail below, the subject matter described herein enables an application to dynamically generate graphical user interface (GUI) displays for web pages, documents, or other files or objects in a manner that varies depending on the particular type of GUI display and the particular application framework or platform (e.g., web, desktop, mobile, etc.) being utilized to generate the GUI display at the client-side. In this manner, the subject matter described herein improves accessibility and enables use of an application across different devices in a manner that is independent of the particular application framework or platform (e.g., web, desktop, mobile, etc.).

For purposes of explanation, the subject matter is described herein primarily in the context of an instance of a virtual application provided by a database system to a client application at a client device over a network to allow a client end user to view one or more GUI displays generated by the instance of the virtual application that graphically depict fields or attributes of data records at the database system corresponding to different objects associated with the virtual application. In response to receiving, from a client application over a network, a request for a web page or other GUI display associated with the virtual application, a contextual component generation service at the database system identifies a destination context associated with the client application based at least in part on the request. In this regard, the destination context characterizes the environment or manner in which the requested information is to be presented, including, but not limited to, identification of the type of page or GUI display being requested, identification of the particular type of client application being utilized for presentation, identification of the particular type of data fields being requested for presentation, identification of the particular type of client device where the page or GUI display is being presented, and/or the like. Based on the destination context, the contextual component generation service automatically generates one or more web components or other containers corresponding to the GUI display (or the constituent GUI display components thereof) having the particular formatting or compatibility with the particular GUI framework appropriate for the identified destination context.

After identifying the destination context, the contextual component generation service at the database system automatically generates one or more constituent web components corresponding to one or more GUI elements associated with the GUI display for populating the GUI display at the client, where the constituent web components are generated or modified to include behavioral code for retrieving data for generating the respective GUI element(s) from a respective data source in accordance with the destination context. In this regard, the contextual component generation service may automatically modify one or more application programming interfaces (APIs) or other endpoints associated with the web component to retrieve the data in a manner suited for the particular type of client application being utilized or the particular type of client device where the page or GUI display is being presented. For example, when the destination context corresponds to a mobile application at a mobile device, the contextual component generation service may automatically modify an API or other endpoint associated with the particular type of page or GUI display being requested within the behavioral code of a web component to retrieve the data via a client-side data service that supports caching at the client device or other offline operation to facilitate performant behavior and improve user experience in a mobile context. On the other hand, when the destination context corresponds to a web browser or other client application at a desktop computing device, the contextual component generation service may automatically modify an API or other endpoint to retrieve the data from the database system over a network. Additionally, the particular type or format of the web component may be selected or generated based on the particular destination context, prior to configuring the APIs or other endpoints of that particular type of web component to retrieve the data in the appropriate manner for the destination context.

In addition to generating the constituent web components for populating the GUI display in a context-sensitive manner, the contextual component generation service also generates an aggregate web component or other container corresponding to the GUI display in a context-sensitive manner based on the destination context to incorporate the constituent components at respective locations within the GUI display based at least in part on a configuration of the GUI display at the database system. As described in greater detail below, the aggregate component includes presentation code for incorporating the constituent components at respective locations within the GUI display in accordance with a configuration of the GUI display at the database system for the particular destination context (e.g., the particular type of client application being utilized for presentation, the particular type of client device where the page or GUI display is being presented, the particular type of data fields being presented, and/or the like). In this regard, the context-sensitive aggregate web component is dynamically generated by the contextual component generation service in a manner such that it has the particular formatting or compatibility with the particular GUI framework and results in the GUI display components being rendered at corresponding locations within the GUI display appropriate for the identified destination context.

By dynamically generating GUI display components in a context-sensitive manner, the subject matter described herein provides a flexible system that supports different implementations for displaying GUI display components across different types of client devices and using different types of client applications on top of a shared layer and fundamental source of truth. In this regard, the particular web page or GUI display may be configured at the database system using a particular data save format indicative of the intent of the user, developer or administrator configuring the page, with generic field container wrappers around individual field references on the page that can pivot based on page type, the client application type and/or the field type, with one or more parent containers that can pivot based on page type, client application type, and/or device type. The contextual component generation service utilizes the server-side configuration of the web page GUI display to automatically pivot the respective containers to generate corresponding web components having the appropriate formatting and compatibility for the destination context consistent with the server-side configuration of the web page GUI display. Thus, an instance or configuration of the virtual application utilizing the particular data save format and generic container wrappers allows a web page GUI display to be dynamically generated in the appropriate format for the destination context associated with a request for the web page GUI display to support mobile, desktop, or other client applications as well as online or offline operation while generating the web page GUI display in a manner that is web friendly, mobile-web friendly, or print friendly, as appropriate. Thus, a developer, administrator or other user does not need to create or define multiple different configurations for a web page GUI display to support different client-side contexts, but rather, may configure the web page GUI display using a generic data save format with generic container wrappers that allow the components for rendering the web page GUI display to be dynamically generated in a manner consistent with the requested destination context.

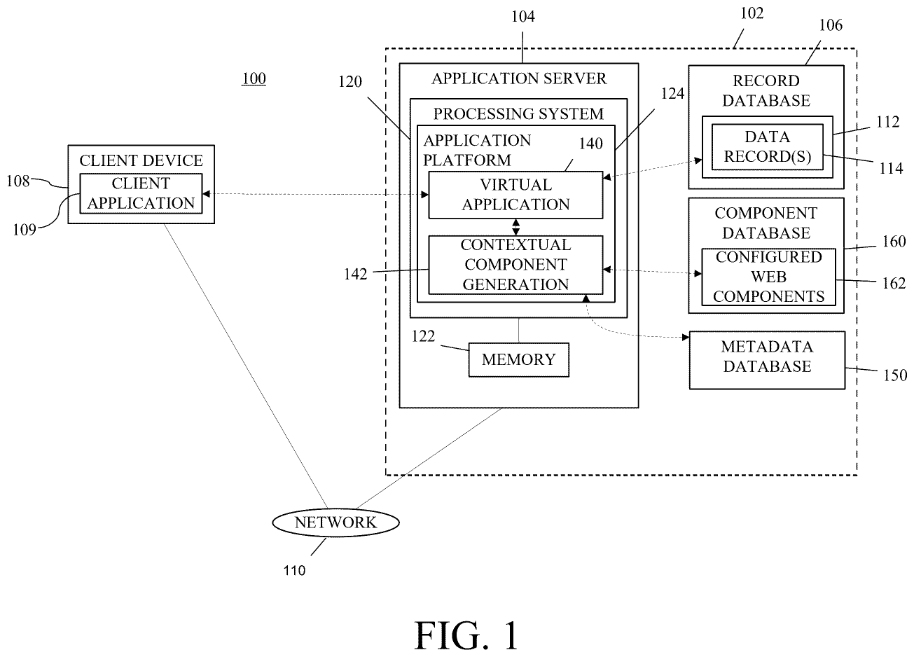

FIG. 1 depicts an exemplary computing system 100 including a database system 102 configurable to provide an application platform 124 capable of concurrently providing instances of one or more virtual applications 140 to client applications 109 at client devices 108 associated with one or more different end users over a communications network 110 (e.g., the Internet or any sort or combination of wired and/or wireless computer network, a cellular network, a mobile broadband network, a radio network, or the like). That said, it should be appreciated that FIG. 1 is a simplified representation of a computing system 100 and is not intended to be limiting. In this regard, it should be noted that although FIG. 1 depicts a database system 102 including multiple different and distinct databases 106, 150, 160, in practice, one or more of the databases 106, 150, 160 may be integrated or otherwise implemented at a common database.

In one or more exemplary implementations, the database system 102 includes one or more application servers 104 that support an application platform 124 capable of providing instances of virtual applications 140, over the network 110, to any number of client devices 108 that users may interact with to view, access or obtain data or other information from one or more data records 114 maintained in one or more data tables 112 at a record database 106 or other repository associated with the database system 102. For example, a record database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the record database 106). In this regard, in one or more implementations, the database system 102 is realized as an on-demand multi-tenant database system that is capable of dynamically creating and supporting virtual applications 140 based upon data from a common database 106 that is shared between multiple tenants, which may alternatively be referred to herein as a multi-tenant database. Data and services generated by the virtual applications 140 may be provided via the network 110 to any number of client devices 108, as desired, where instances of the virtual application 140 may be suitably generated at run-time (or on-demand) using a common application platform 124 that securely provides access to the data in the record database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the record database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or other suitable network interfaces that support communications to/from the network 110 coupled thereto. The application server 104 also includes or otherwise accesses a data storage element 122 (or memory), which may be realized as a local disk, hard disk, random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to support the subject matter described herein.

The client device 108 generally represents an electronic device coupled to the network 110 that may be utilized by a user to access an instance of the virtual application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems, in which case the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual application 140 using a networking protocol. In some implementations, the client application 109 is realized as a web browser or similar local client application executed by the client device 108 that contacts the application platform 124 at the application server 104 using a networking protocol, such as hypertext transport protocol secure (HTTPS). In this manner, the client application 109 may be utilized to access or otherwise initiate an instance of a virtual application 140 hosted by the database system 102, where the virtual application 140 provides one or more web page GUI displays within the client application 109 that include GUI elements for interfacing and/or interacting with records 114 maintained at the record database 106.

In some implementations, when client application 109 is realized as a native application or mobile application at a mobile device, the instance of the client application 109 may be configurable to utilize a client-side data service that supports interactions with the database system 102 and independently maintains its own associated cache of data, alternatively referred to herein as the data service cache. For example, an administrator associated with a resource owner may configure application configuration metadata at the database system 102 to include or otherwise incorporate the client-side data service, such that the code or other computer-executable programming instructions associated with the data service is downloaded from the database system 102 to a data storage element or memory at the client device 108 to be integrated with or otherwise incorporated into the native mobile application. To support the client-side data service, the client application 109 downloads application configuration metadata that indicates the client-side data service is to be utilized to retrieve data from the data records 114 maintained at the database system 102. Thereafter, based on the downloaded application configuration metadata indicating the client-side data service should be utilized, the client application 109 generates or otherwise provides requests for data from the database system 102 to the client-side data service, such that the client-side data service functions as an intermediary between the client application 109 and the database system 102. The client-side data service utilizes one or more APIs at the database system 102 to download record data from the data records 114 corresponding to the various components to be incorporated into the client application 109, and the client-side data service utilizes the local data service cache to support sharing record data across different components that may be integrated into the client application 109 to improve efficiency and reduce complexity. Additionally, the client-side data service and the corresponding data records 114 at the database system 102 allow for server-side control and customization of the client application 109. In one or more implementations, the client-side data service is realized as the Salesforce Lightning Data Service (LDS), where the configuration of the client application 109 to utilize the client-side data service is alternatively referred to herein as the LDS mode.

Still referring to FIG. 1, in exemplary implementations, the record database 106 stores or otherwise maintains data for integration with or invocation by a virtual application 140 in objects organized in object tables 112. In this regard, the record database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application, with each different type of object having a corresponding object table 112 that includes columns or fields corresponding to the different parameters or criteria that define a particular instance of that object. In some implementations, the record database 106 stores or otherwise maintains application objects (e.g., an application object type) where the application object table 112 includes columns or fields corresponding to the different parameters or criteria that define a particular virtual application 140 capable of being generated or otherwise provided by the application platform 124 on a client device 108. In this regard, the record database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that instance of the virtual application 140.

In exemplary implementations, the record database 106 stores or otherwise maintains additional database objects for association and/or integration with a virtual application 140, which may include custom objects and/or standard objects. For example, an administrator user associated with a particular resource owner may utilize an instance of a virtual application 140 to create or otherwise define a new custom field to be added to or associated with a standard object, or define a new custom object type that includes one or more new custom fields associated therewith. In some implementations, the record database 106 may also maintain metadata that defines or describes the fields, process flows, workflows, formulas, business logic, validation rules, structure and other database components or constructs that may be associated with a particular database object.

In the illustrated implementation, the database system 102 also includes a metadata database 150 that stores or otherwise maintains metadata that defines or describes the fields, process flows, formulas, business logic, structure and other database components or constructs that may be associated with various database objects, virtual applications 140 and/or the application platform 124. For purposes of supporting dynamic component generations described herein, the metadata database 150 may store or otherwise maintain endpoint metadata that includes APIs or other information identifying endpoints for retrieving information associated with the respective fields or other attributes of the different standard and/or custom database objects maintained in the record database 106 in different programming languages or other formats suitable for a particular destination context, as described in greater detail below.

In one or more exemplary implementations, the application platform 124 is configurable to facilitate or generate an instance of a virtual application 140 at run-time or on-demand using configured web components 162 associated with the web application that are maintained in a component database 160 coupled to the application server 104. As described in greater detail below, the configured web components 162 are created, defined, or otherwise configured by a developer, creator, administrator or other user associated with a particular tenant who inputs, selects, configures or otherwise defines values for fields or parameters for instances of web component templates that have been added or selected for integration with a particular web page GUI display associated with the virtual application 140 for that particular tenant's configuration. For example, a developer of a web application may configure, define or otherwise provide other information for one or more fields of a particular database object type for an instance of a web component template added to a web page GUI display of the virtual application, which, in turn, may be utilized by the application platform 124 and/or a client application 109 to retrieve data from the record database 106 and/or the metadata database 150 for incorporation within the virtual application 140 by populating or otherwise generating the instance of the configured web component 162 using the retrieved data at run-time or on-demand.

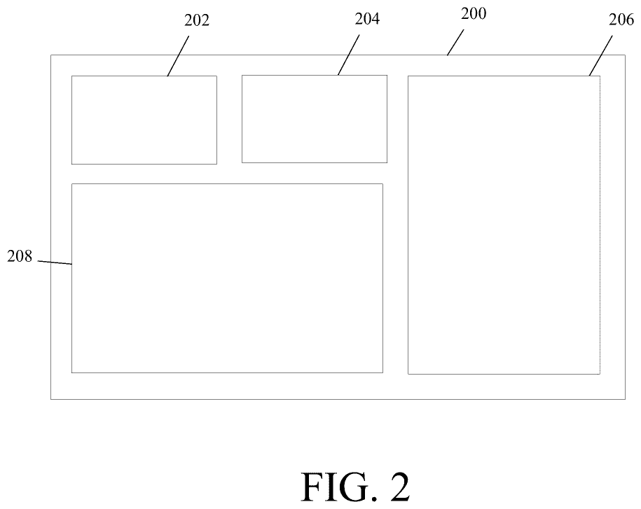

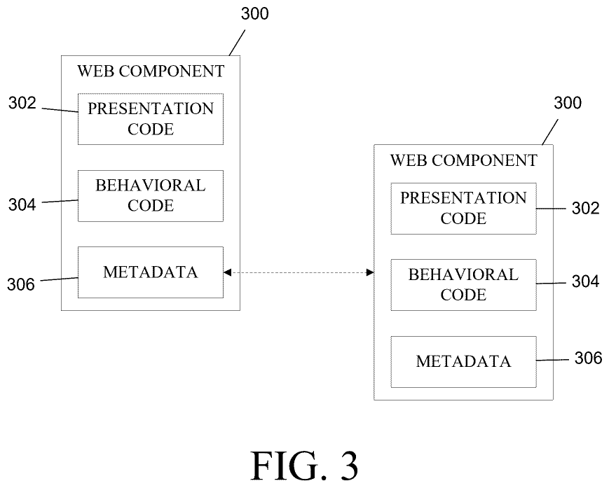

For example, referring to FIGS. 2-3 with continued reference to FIG. 1, in one or more implementations, the processing system 120 executes programming instructions that are configurable cause the application platform 124 to create, generate, or otherwise facilitate a page generation service capable of generating one or more web page GUI displays corresponding to a virtual application 140 created or otherwise developed by a user based on the configured web components 162 associated with the particular instance of the virtual application 140, for example, by retrieving and rendering the configured web components 162 at run-time in accordance with the user-defined configuration.

FIG. 2 depicts an exemplary web page GUI display 200 that includes GUI display components 202, 204, 206, 208 that are dynamically generated at run-time using corresponding web components 162 added to the layout of the web page GUI display 200. For example, a developer user may utilize the page builder feature of the application platform 124 to add instances of web component templates to a web page and define values for the fields associated with the respective web component templates. In this regard, the configurable web component templates generally represent self-contained and reusable elements or other resources that may be added or otherwise incorporated into a web page GUI display and generated or otherwise rendered at run-time in accordance with user-defined or user-configured values for various metadata fields or parameters of the respective web component template. For example, the configurable web component templates may correspond to configurable web components for various GUI elements, such as buttons, text boxes, lists, menus, and/or the like, which may be added to a web page GUI display in a drag and drop manner and then manually configured by a developer user. The page builder feature of the application platform 124 may be configurable to generate and store configured instances of the web component templates in the component database 160 as configured web components 162 associated with that user or tenant's instance of the virtual application 140 that maintains the user-defined values for the respective instances of the web component templates in association with the other code and/or data defining the layout, rendering, or behavior of the respective web component templates added to the respective web page GUI display.

FIG. 3 depicts an exemplary relationship between configured web components 300, 310 suitable for use as configured web components 162 in the computing system of FIG. 1 to generate the respective GUI display components 202, 204, 206, 208 of a web page GUI display 200 associated with an instance of a virtual application 140. Exemplary implementations of the configured web components 162, 300, 310 include presentation code 302, 312 (e.g., Hypertext Markup Language (HTML), cascading style sheet (CSS), and/or the like) defining the manner in which the configured web component 162, 300, 310 is to be displayed, rendered or otherwise presented by the client application 109. The configured web component 162, 300, 310 may also include behavioral code 304, 314 (e.g., JavaScript or other client-side executable code) defining the event-driven behavior of the configured web component 162, 300 within the client application 109 (e.g., in response to user actions, server actions, an event associated with another web component, etc.). The configured web component 162, 300, 310 also includes the user-defined metadata 306, 316 for the configured web component 162, 300, 310 which may be invoked, referenced, or otherwise utilized by the presentation code 302, 312 and/or behavioral code 304, 314 to generate and render the configured web component 162, 300, 310. Accordingly, the configured web components 162, 300, 310 may be dynamic, with the content and/or behavior thereof varying each time a web page GUI display including one or more configured web component(s) 162, 300, 310 is viewed or accessed.

In some implementations, the web page GUI display 200 may be implemented or otherwise realized as an aggregate web component 162, 300 that includes HTML code or other presentation code 302 that defines the layout, graphical structure, spatial arrangement or other visual characteristics of the constituent GUI display components 202, 204, 206, 208 contained therein along with JavaScript code or other client-side executable behavioral code 304 that defines the event-driven behavior associated with the web page GUI display 200 and constituent component metadata 306 identifying the respective configured constituent GUI display components 162, 310 to be invoked and rendered within the web page GUI display 200 in accordance with the user-defined positioning and spatial arrangement of the constituent GUI display components 202, 204, 206, 208. In such implementations, when rendering a web page GUI display 200 based on a URL or web page file of a virtual application 140, the client application 109 retrieves and executes the presentation code to generate the GUI display components 202, 204, 206, 208 within the web page GUI display 200 associated with the virtual application 140 by utilizing the constituent component metadata 306 to retrieve and dynamically render the configured constituent web components 162, 310 to populate the respective regions of the web page GUI display 200. Additional implementation details not germane to this disclosure are described in U.S. Pat. No. 11,321,422.

Referring to FIGS. 1-3, in one or more exemplary implementations, to support dynamic component generations within the context of an instance of a virtual application 140, a web page GUI display 200 associated with that instance of the virtual application 140 is configured or otherwise designed by a developer, administrator or other user associated with the tenant or resource owner for that instance of the virtual application 140 using configured constituent web components 162 having generic field container wrappers around individual field references around the respective fields of the data records 114 to be included or incorporated into the web page, with those field references also utilizing a particular data save format indicate the intended fields.

For example, the data save format utilized by the metadata 316 of the configured constituent web components 162, 310 for a respective web page GUI display 200 may define a generic record context and reference its fields in the format “Record. Field,” where the Field parameter references or invokes the value of the identified field of the currently displayed record identified by the Record parameter (e.g., where Record. Name refers to the value of the Name field of the currently displayed record, etc.). Additionally, the field references can reference other records via relationship fields denoted in the format “Record. Relationship. Field” (e.g., to refer to the currently displayed record over the relationship with the name “Relationship” and the particular value for the identified field at that destination) or “Record.Relationship.Object.Field” (e.g., to refer to the currently displayed record over the polymorphic relationship with the name “Relationship” pointing to a particular type of database object identified by the Object parameter and the particular value for the identified field at that destination). In a similar manner, custom fields or custom objects may be referenced in an equivalent manner, for example, using the format “Record.Relationship__r: EntityName__c. Name__c (e.g., the currently displayed record, over the custom polymorphic relationship “Relationship__r”, specifically for when that relationship points to a custom object “EntityName__c” and the custom field “Name__c” at that destination), while internally saving the field reference at the database system 102 using identifiers (e.g., Record.00X:00E.00Y, where 00X is the ID for the Relationship__r custom relationship, 00E is the ID for the custom entity, and 00Y is the ID of the custom field) to support integrity and exportation of custom metadata between tenants or resource owners when custom relationships or custom fields are capable of being renamed.

Additionally, the presentation code 312, the behavioral code 314 and/or the metadata 316 of the configured constituent web components 162, 310 may utilize one or more generic field wrappers associated with a respective field reference to allow for the respective GUI display component 202, 204, 206, 208 corresponding to the constituent web components 162, 310 to dynamically pivot at run-time in a context-sensitive manner to suit the particular destination context. In this regard, the application platform 124 implements or otherwise supports a dynamic contextual component generation service 142 configurable to retrieve the configured web components 162 corresponding to a requested web page GUI display and utilize the identified destination context associated with the client application 109 to dynamically generate context-sensitive web components to be provided to the client application 109 responsive to the request. For example, based on the identified destination context, the contextual component generation service 142 may be configurable to identify the appropriate format or language for API calls or other endpoints for retrieving the referenced fields of a data record 114 to be presented and automatically modify the generic field wrappers associated with those field references to utilize context-sensitive field wrappers that include the appropriate APIs, endpoints, or other behavioral code for retrieving or invoking those fields of the data record 114. In this regard, the metadata database 150 may maintain information identifying the different APIs, endpoints, programming languages, data formats and/or the like to be utilized for a particular type of data record 114 and/or a particular type of field of a data record 114 associated with a particular destination context at the client-side. For example, for a mobile application or mobile device, the contextual component generation service 142 may be configurable to modify a generic field wrapper within the behavioral code 314 associated with a particular constituent component 310 to retrieve the referenced field of the data record 114 via a client-side data service that supports caching at the client device 108 (e.g., to support offline operation), while for a web browser or other desktop application, the contextual component generation service 142 may modify the generic field wrapper within the behavioral code 314 to retrieve the referenced field of the data record 114 from the database 106 at the database system 102 via an API supported by the application platform 124.

In a similar manner, based on the identified destination context, the contextual component generation service 142 may modify any generic field wrappers within the presentation code 312 to modify presentation of the respective fields in a context-sensitive manner. In this regard, the metadata database 150 may maintain information identifying the different GUI elements or other GUI display components, HTML code segments, layouts and/or the like to be utilized for a particular type of data record 114 and/or a particular type of field of a data record 114 associated with a particular destination context at the client-side. For example, for a mobile application or mobile device, the contextual component generation service 142 may be configurable to modify a generic field wrapper within the presentation code 312 associated with a particular constituent component 310 to utilize a mobile friendly or mobile-web friendly GUI element or other display component, while for a web browser or other desktop application, the contextual component generation service 142 may modify the generic field wrapper within the presentation code 312 to utilize a web friendly or print friendly GUI element or other display component.

In exemplary implementations, the contextual component generation service 142 also dynamically generates a context-sensitive web component corresponding to the aggregate web component 300 for the web page GUI display 200 to be provided to the client application 109 responsive to the request. In this regard, in a similar manner as described above, the contextual component generation service 142 modifies generic field wrappers within the presentation code 302 and/or the behavioral code 304 of the aggregate web component 300 to utilize the appropriate APIs, endpoints, GUI elements, page layouts and/or the like for the particular destination context, while modifying the metadata 306 to incorporate the dynamically generated context-sensitive constituent web components. In some implementations, depending on the particular destination context, the contextual component generation service 142 may utilize the generic field wrappers to move one or more API calls or other endpoints from the constituent web components to the aggregate web component to improve performance and/or the like. For example, when the destination context corresponds to a mobile application or mobile device, the contextual component generation service 142 may generate a context-sensitive aggregate web component for the web page GUI display that includes an API call and/or corresponding behavioral code to download or otherwise retrieve values for multiple fields of a particular data record 114 to be stored or otherwise maintained client-side and piped down to the constituent web components by modifying the generic field wrappers of the constituent web components to retrieve the field values via JavaScript Object Notation (JSON) data associated with the client application 109 or otherwise via the client-side data service or cache. In this manner, the contextual component generation service 142 may improve performance by reducing the number or frequency of requests for fields of a data record 114 transmitted to the database system 102 over the network 110 while also allowing the instance of the virtual application 140 presented within the client application 109 to maintain performance and continue execution in an offline mode when a connection to the network 110 and/or the database system 102 is unavailable.

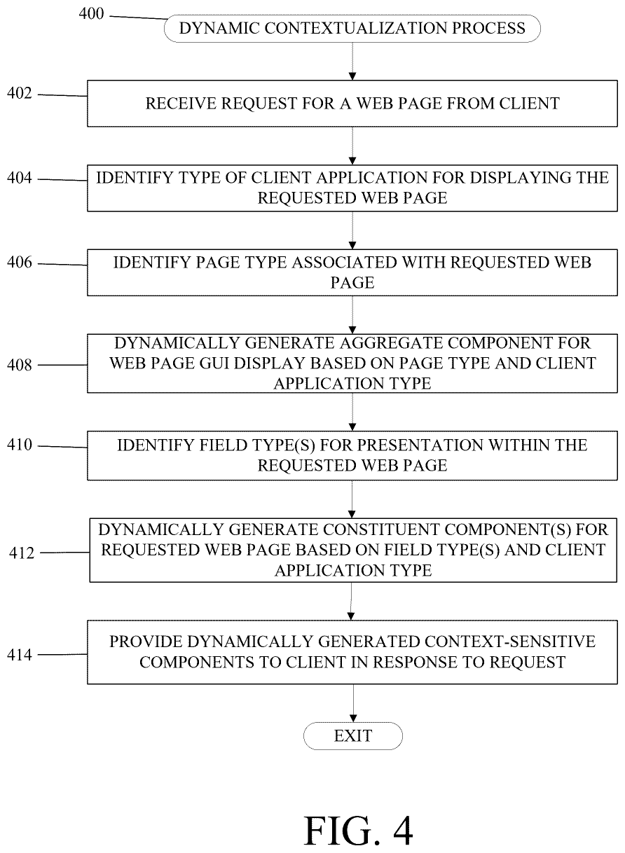

FIG. 4 depicts an exemplary dynamic contextualization process 400 suitable for implementation by a contextual component generation service associated with an application platform to support dynamic contextualization of an instance of a virtual application generated at run-time based on data obtained from a database system and perform additional tasks, functions, and/or operations described herein. For illustrative purposes, the following description may refer to elements mentioned above in connection with FIGS. 1-3. It should be appreciated that the dynamic contextualization process 400 may include any number of additional or alternative tasks, the tasks need not be performed in the illustrated order and/or the tasks may be performed concurrently, and/or the dynamic contextualization process 400 may be incorporated into a more comprehensive procedure or process having additional functionality not described in detail herein. Moreover, one or more of the tasks shown and described in the context of FIG. 4 could be omitted from a practical implementation of the dynamic contextualization process 400 as long as the intended overall functionality remains intact.

Referring to FIG. 4 with continued reference to FIGS. 1-3, in exemplary implementations, the dynamic contextualization process 400 initializes or begins in response to receiving a request for a particular web page or other GUI display from a user of a client application at a client device and identifying a destination context associated with the request including identification of a page type associated with the requested web page and the type of client application to be utilized for displaying the web page (tasks 402, 404, 406). For example, a user at a client device 108 may manipulate or otherwise interact with a GUI element presented within a GUI display of the client application 109 to select, input or otherwise provide indication of a desired web page associated with an instance of a virtual application 140 to be presented. The client application 109 may transmit or otherwise provide a corresponding request for a particular web page GUI display URL address to the application platform 124 at the database system 102 over the network 110 that includes one or more parameters identifying the particular type of client application 109 and/or the particular type of client device 108 from which the request originated, such as, for example, whether the client application 109 is a web browser, a native mobile application (e.g., a field service mobile application) or another type of client-side application. Based on the URL address and/or the particular type of client application, the contextual component generation service 142 may utilize the metadata database 150 and/or the component database 160 to determine the particular page type associated with the particular URL address or web page GUI display being requested. For example, in the context of a field service virtual application, the contextual component generation service 142 may identify or otherwise determine whether the requested web page corresponds to a record page (e.g., a work order, a service appointment or the like), a service document, or another type of page supported by the field service virtual application.

In an exemplary implementation, the dynamic contextualization process 400 automatically generates a top-level aggregate web component for the requested web page based on the requested page type and the type of client application (task 408). For example, when the client application 109 is realized as a native mobile application executing at or on a mobile client device, the contextual component generation service 142 may retrieve a configured web component 162, 300 defined for the requested web page GUI display and utilize the metadata database 150 to dynamically generate corresponding presentation code and/or behavioral code for rendering the requested web page GUI display in a mobile friendly or mobile-web friendly format using a language or format compatible with the requesting type of client application 109. Additionally, the contextual component generation service 142 may modify the presentation code and/or behavioral code based on the particular page type being requested. For example, in the context of a field service virtual application, when the requested web page corresponds to a service document, the contextual component generation service 142 may modify the presentation code and/or behavioral code to support a read-only behavior and printer friendly format by disabling, deactivating or otherwise replacing any GUI elements for editing field values presented within the service document. In addition to dynamically adapting presentation of the requested web page GUI display to the destination context associated with the request, when the client application type corresponds to a mobile application, the contextual component generation service 142 also automatically generates or otherwise modifies any generic field wrappers for the requested web page GUI display within the aggregate web component for the requested web page GUI display to retrieve fields of a data record 114 to be presented via a client-side data service to download field values for the data record 114 from the database 106 and cache the downloaded field values for the fields of the data record 114 at the client device 108. On the other hand, when the client application type corresponds to a web browser or other desktop application, the contextual component generation service 142 also automatically generates or otherwise modifies any generic field wrappers for the requested web page GUI display within the aggregate web component for the requested web page GUI display to retrieve fields of a data record 114 from the database 106 via the application platform 124 at the database system 102.

Still referring to FIG. 4, with continued reference to FIGS. 1-3, in exemplary implementations, the dynamic contextualization process 400 identifies or otherwise determines field types for the requested fields to be presented within the requested web page GUI display and dynamically generates corresponding lower level constituent web components to be incorporated with the top level aggregate web component based on the respective field type, the requested page type and the type of destination client application (tasks 410, 412). In this regard, the contextual component generation service 142 retrieves the configured constituent web components 162, 310 defined for the requested web page GUI display and utilizes the metadata database 150 to dynamically generate corresponding presentation code, behavioral code and/or metadata for rendering the respective GUI display component 202, 204, 206, 208 for a respective constituent web components 162, 310 in a manner that is influenced by the field type, the type of destination client application and the requested page type. Depending on the particular field type and the particular page type, the contextual component generation service 142 may utilize the metadata database 150 to generate presentation code for the respective constituent web component for rendering a GUI element associated with the respective field or other graphical representation of the respective field for the particular field type using a language or format that is compatible with the type of destination client application and the requested page type. For example, in the context of a field service virtual application, when the requested web page corresponds to a record page, the contextual component generation service 142 may modify the presentation code for the respective web component to provide a GUI element that supports editing or otherwise interacting with a displayed field value presented on the record page in a language or format that is compatible with or otherwise executable by the client application 109. Additionally, depending on the particular type of client application, the contextual component generation service 142 may modify the behavioral code for the respective web component to retrieve the value for the particular field from a particular source or location suitable for the particular type of client application. For example, when the client application 109 is realized as a native mobile application executing at or on a mobile client device, the contextual component generation service 142 may modify the behavioral code for the respective web component to retrieve the value for the particular field via a client-side data service, a cache at the client device 108, or via JSON data maintained by the client application 109 at the client device 108 (e.g., by substituting a GraphQL API call to a client-side data service in place of a getRecord API call to the application platform 124), such that the field value is effectively piped down to the constituent web component from the top level aggregate web component without the constituent web component transmitting a request to the database system 102.

Still referring to FIG. 4, after dynamically generating the context-sensitive web components for the requested web page GUI display, the dynamic contextualization process 400 transmits or otherwise provides the context-sensitive web components to the client in response to the request for execution at the client (task 414). For example, after the contextual component generation service 142 dynamically generates the aggregate web component for the requested web page GUI display based on the destination context that incorporates the dynamically generated context-sensitive constituent web components, the application platform 124 may automatically generate or otherwise construct an HTML file or other executable container including the web components for the requested web page GUI display and provide the resulting HTML file to the client device 108 over the network 110 for execution by the client application 109. Thereafter, the client application 109 executes the respective presentation code 302, 312 and behavioral code 304, 314 associated with the respective web components utilizing the metadata 306, 316 provided therewith to download or otherwise retrieve current values for the fields of a data record 114 from the database system 102 and then dynamically generate the web page GUI display 200 associated with the virtual application 140 that includes the server-side defined GUI display components 202, 204, 206, 208 for the respective field values of the data record 114 with the appropriate layout, behavior and format for the particular destination context.

For example, in the context of a field service application, when the destination context corresponds to a native field service mobile application requesting a service document, the contextual component generation service 142 dynamically generates web components for presenting field values in a read-only and printer-friendly format via a client-side data service using GraphQL APIs, which, in turn, results in the client application 109 generating the service document web page GUI display depicting field values for a selected data record 114 in a read-only, mobile friendly, and printer-friendly format. On the other hand, when the destination context corresponds to a native field service mobile application requesting a record page, the contextual component generation service 142 dynamically generates web components for presenting field values in an editable format via a client-side data service using GraphQL APIs, which, in turn, results in the client application 109 generating the record page web page GUI display depicting field values for a selected data record 114 using selectable or manipulable GUI elements for interacting with the field values via the client-side data service using GraphQL APIs in a mobile friendly format.

As another example, when the destination context corresponds to a web browser application requesting a service document, the contextual component generation service 142 dynamically generates web components for presenting field values in a read-only and printer-friendly format using getRecord API calls to the application platform 124, which, in turn, results in the client application 109 generating the service document web page GUI display depicting field values for a selected data record 114 in a read-only and printer-friendly format using current field values retrieved from the database 106 via the application platform 124 using getRecord API calls. On the other hand, when the destination context corresponds to a web browser application requesting a record page, the contextual component generation service 142 dynamically generates web components for presenting field values in an editable format that results in the client application 109 generating the record page web page GUI display depicting field values for a selected data record 114 using selectable or manipulable GUI elements for interacting with the field values associated with the data record 114 in the table 112 of the record database 106 and performing CRUD operations via one or more APIs associated with the application platform 124.

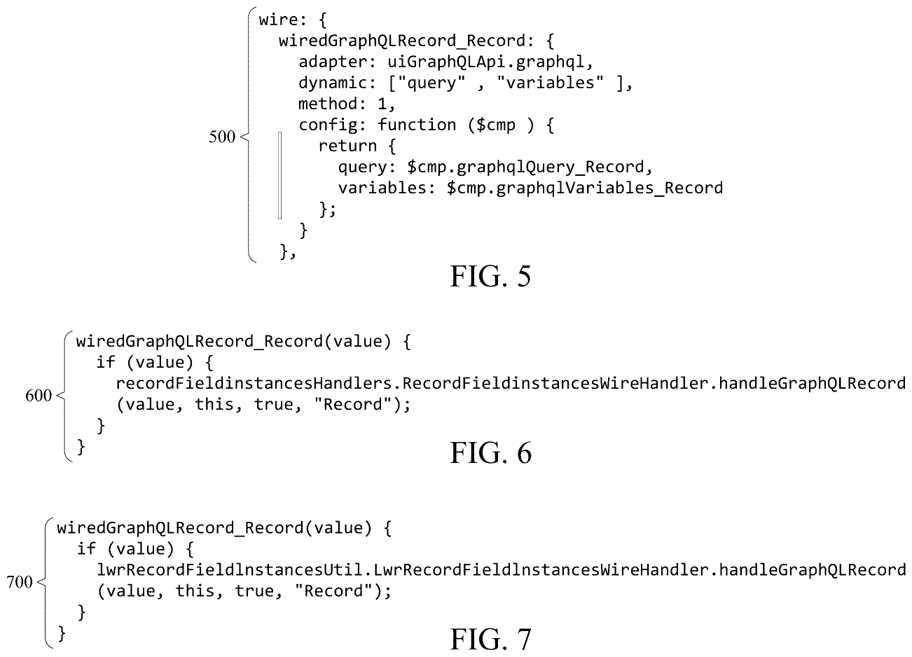

FIGS. 5-7 depict an exemplary relationship between a generic code segment 500 suitable for use in a web component 162 having generic field container wrappers around individual field references around the respective fields of the data records 114 utilizing a particular data save format indicate the intended fields, a corresponding desktop-specific version 600 of the code segment 500 when the destination context corresponds to a web browser at a computing device, and a corresponding mobile-specific version 700 of the code segment 500 when the destination context corresponds to a mobile application at a mobile device. As described above, the contextual component generation service 142 automatically modifies the API or other endpoint associated with generic code segment 500 to retrieve the data from the database system in the desktop-specific code segment 600 or to retrieve the data from the client-side data service in the mobile-specific code segment 700. In this regard, when the contextual component generation service 142 retrieves a web component 162 including the generic code segment 500, the contextual component generation service 142 parses the web component 162 to identify the generic field wrapper code and API call or endpoint of the generic code segment 500 to transform the API call to the appropriate format for the destination context, and correspondingly transforms the generic field wrapper code to a format suitable for the destination context, resulting in the desktop-friendly code segment 600 or the mobile-friendly code segment 700.

By virtue of the subject matter described herein, a web page GUI display associated with an instance of a virtual application may be designed in an extensible and flexible manner by utilizing web components having field references using a universal data save format and generic field wrappers that allow for web components to be dynamically generated at run-time using appropriate API calls, endpoints, JavaScript or other behavioral code, and HTML or other presentation code tailored to the particular destination context when or where the web page GUI display is to be presented. Thus, a web page GUI display associated with an instance of a virtual application may be designed in a universal manner that allows for presentation via desktop applications, web browser applications, mobile applications, or any other sort of client application, at any other sort of client device, while supporting both offline or online operations, and providing other desired behaviors (e.g., read-only, printer-friendly, etc.) independent of the particular destination platform or framework being utilized to generate the web page GUI display.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

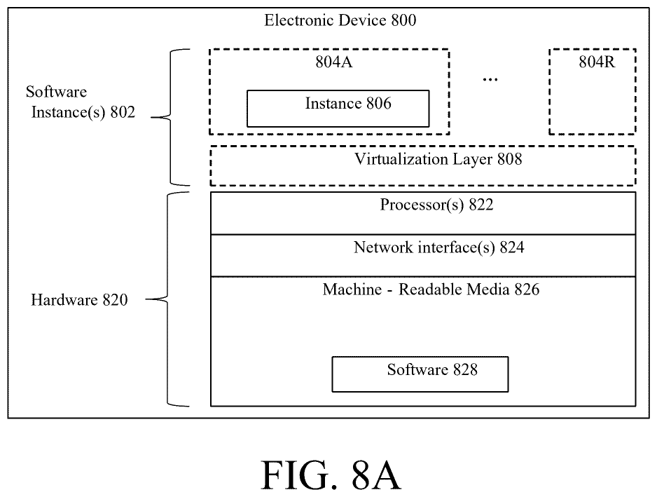

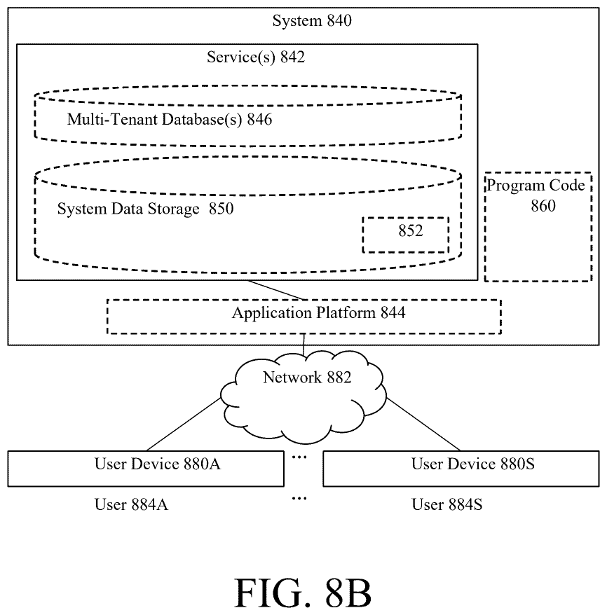

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Each of the previously described applications and related services may be implemented in one or more electronic devices 800. In one implementation: 1) each of the clients is implemented in a separate one of the electronic devices 800 (e.g., in end user devices where the software 828 represents the software to implement clients to interface directly and/or indirectly with the contextual component generation service(e.g., software 828 represents a web browser, a native client, a portal, a command-line interface, and/or an application programming interface (API) based upon protocols such as Simple Object Access Protocol (SOAP), Representational State Transfer (REST), etc.)); 2) the contextual component generation service is implemented in a separate set of one or more of the electronic devices 800 (e.g., a set of one or more server devices where the software 828 represents the software to implement the dynamic localization service); and 3) in operation, the electronic devices implementing the clients and the contextual component generation service would be communicatively coupled (e.g., by a network) and would establish between them (or through one or more other layers and/or or other services) connections for submitting requests to the dynamic localization service. Other configurations of electronic devices may be used in other implementations (e.g., an implementation in which the client and the contextual component generation service are implemented on a single one of electronic device 800).

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine (such as Docker Engine by Docker, Inc. or rkt in Container Linux by Red Hat, Inc.) running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

FIG. 8B is a block diagram of a deployment environment according to some example implementations. A system 840 includes hardware (e.g., a set of one or more server devices) and software to provide service(s) 842, including one or more services configurable to support a dynamic localization service. In some implementations the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 840 is coupled to user devices 880A-880S over a network 882. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 840 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 850.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 862 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers'creation and management of applications, which may be saved as metadata by save routines. Invocations to such applications, including by the dynamic localization service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method comprising:
receiving, at a database system from a client application at a client device over a network, a request for a graphical user interface (GUI) display associated with a virtual application supported by the database system;
identifying, at the database system, a destination context associated with the client application based at least in part on the request;
generating, at the database system, one or more constituent components corresponding to one or more GUI elements associated with the GUI display based on the destination context, wherein a respective constituent component of the one or more constituent components comprises behavioral code for retrieving data from a respective data source in accordance with the destination context;
generating, at the database system, an aggregate component corresponding to the GUI display based on the destination context, the aggregate component comprising presentation code for incorporating the one or more constituent components at respective locations within the GUI display based at least in part on a configuration of the GUI display at the database system; and
providing, from the database system to the client application over the network, the aggregate component and the one or more constituent components in response to the request, wherein the client application is configurable to execute the behavioral code to retrieve the data from the respective data source for a respective GUI element of the one or more GUI elements and execute the presentation code to render the data at a respective location of the respective GUI element within the GUI display.

2. The method of claim 1, wherein identifying the destination context comprises identifying an application type associated with the client application comprises a mobile application, wherein generating the one or more constituent components comprises modifying the behavioral code of the respective constituent component to retrieve the data from a data service at the client device.

3. The method of claim 2, wherein the client application is configurable to execute the behavioral code to retrieve the data from a cache at the client device via the data service.

4. The method of claim 2, wherein generating the aggregate component comprises modifying the presentation code to incorporate the one or more constituent components at respective locations within the GUI display using a mobile friendly layout.

5. The method of claim 1, wherein identifying the destination context comprises identifying an application type associated with the client application comprises a mobile application, wherein generating the aggregate component comprises modifying the presentation code to incorporate the one or more constituent components at respective locations within the GUI display using a mobile friendly layout.

6. The method of claim 1, wherein identifying the destination context comprises identifying a page type associated with the request comprises a document, wherein generating the aggregate component comprises modifying the presentation code to incorporate the one or more constituent components in a read-only manner.

7. The method of claim 1, wherein generating the one or more constituent components comprises:
parsing the behavioral code of the respective constituent component to identify a reference to a field of a data record in a database at the database system in a predefined format; and
automatically modifying the reference to an endpoint for obtaining a value for the field of the data record in accordance with an application type associated with the client application.

8. The method of claim 1, wherein generating the one or more constituent components comprises:
parsing the behavioral code of the respective constituent component to identify a generic field wrapper associated with a reference to a field of a data record in a database at the database system; and
automatically modifying the generic field wrapper to utilize an application programming interface (API) associated with an application type associated with the client application.

9. At least one non-transitory machine-readable storage medium that provides instructions that, when executed by at least one processor, are configurable to cause the at least one processor to perform operations comprising:
receiving, from a client application at a client device, a request for a graphical user interface (GUI) display associated with a virtual application supported by a database system coupled to the client device over a network;
identifying a destination context associated with the client application based at least in part on the request;
generating one or more constituent components corresponding to one or more GUI elements associated with the GUI display based on the destination context, wherein a respective constituent component of the one or more constituent components comprises behavioral code for retrieving data from a respective data source in accordance with the destination context;
generating an aggregate component corresponding to the GUI display based on the destination context, the aggregate component comprising presentation code for incorporating the one or more constituent components at respective locations within the GUI display based at least in part on a configuration of the GUI display at the database system; and
providing, to the client application, the aggregate component and the one or more constituent components in response to the request, wherein the client application is configurable to execute the behavioral code to retrieve the data from the respective data source for a respective GUI element of the one or more GUI elements and execute the presentation code to render the data at a respective location of the respective GUI element within the GUI display.

10. The at least one non-transitory machine-readable storage medium of claim 9, wherein the instructions are configurable to cause the at least one processor to identify an application type associated with the client application comprises a mobile application, wherein generating the one or more constituent components comprises modifying the behavioral code of the respective constituent component to retrieve the data from a data service at the client device.

11. The at least one non-transitory machine-readable storage medium of claim 10, wherein the instructions are configurable to cause the at least one processor to modify the presentation code to incorporate the one or more constituent components at respective locations within the GUI display using a mobile friendly layout.

12. The at least one non-transitory machine-readable storage medium of claim 9, wherein the instructions are configurable to cause the at least one processor to identify an application type associated with the client application comprises a mobile application, wherein generating the aggregate component comprises modifying the presentation code to incorporate the one or more constituent components at respective locations within the GUI display using a mobile friendly layout.

13. The at least one non-transitory machine-readable storage medium of claim 9, wherein the instructions are configurable to cause the at least one processor to identify a page type associated with the request comprises a document, wherein generating the aggregate component comprises modifying the presentation code to incorporate the one or more constituent components in a read-only manner.

14. The at least one non-transitory machine-readable storage medium of claim 9, wherein the instructions are configurable to cause the at least one processor to:
parse the behavioral code of the respective constituent component to identify a reference to a field of a data record in a database at the database system in a predefined format; and
automatically modify the reference to an endpoint for obtaining a value for the field of the data record in accordance with an application type associated with the client application.

15. The at least one non-transitory machine-readable storage medium of claim 9, wherein the instructions are configurable to cause the at least one processor to:
parse the behavioral code of the respective constituent component to identify a generic field wrapper associated with a reference to a field of a data record in a database at the database system; and
automatically modify the generic field wrapper to utilize an application programming interface (API) associated with an application type associated with the client application.

16. A computing device comprising:
at least one non-transitory machine-readable storage medium that stores software for a contextual component generation service; and
at least one processor, coupled to the at least one non-transitory machine-readable storage medium, to execute the software that implements the contextual component generation service and that is configurable to:
receive, at a database system from a client application at a client device over a network, a request for a graphical user interface (GUI) display associated with a virtual application supported by the database system;
identify, at the database system, a destination context associated with the client application based at least in part on the request;
generate, at the database system, one or more constituent components corresponding to one or more GUI elements associated with the GUI display based on the destination context, wherein a respective constituent component of the one or more constituent components comprises behavioral code for retrieving data from a respective data source in accordance with the destination context;
generate, at the database system, an aggregate component corresponding to the GUI display based on the destination context, the aggregate component comprising presentation code for incorporating the one or more constituent components at respective locations within the GUI display based at least in part on a configuration of the GUI display at the database system; and
provide, from the database system to the client application over the network, the aggregate component and the one or more constituent components in response to the request, wherein the client application is configurable to execute the behavioral code to retrieve the data from the respective data source for a respective GUI element of the one or more GUI elements and execute the presentation code to render the data at a respective location of the respective GUI element within the GUI display.

17. The computing device of claim 16, wherein the contextual component generation service is configurable to identify an application type associated with the client application comprises a mobile application, wherein generating the one or more constituent components comprises modifying the behavioral code of the respective constituent component to retrieve the data from a data service at the client device.

18. The computing device of claim 16, wherein the contextual component generation service is configurable to identify an application type associated with the client application comprises a mobile application, wherein generating the aggregate component comprises modifying the presentation code to incorporate the one or more constituent components at respective locations within the GUI display using a mobile friendly layout.

19. The computing device of claim 16, wherein the contextual component generation service is configurable to identify a page type associated with the request comprises a document, wherein generating the aggregate component comprises modifying the presentation code to incorporate the one or more constituent components in a read-only manner.

20. The computing device of claim 16, wherein the contextual component generation service is configurable to:
parse the behavioral code of the respective constituent component to identify a reference to a field of a data record in a database at the database system in a predefined format; and
automatically modify the reference to an endpoint for obtaining a value for the field of the data record in accordance with an application type associated with the client application.
